(19) United States
(12) Patent Application Publication
(10) Pub. No.: US 2006/0240866 A1
(43) Pub. Date: Oct. 26, 2006

(54) Method and system for controlling a portable communication device based on its orientation

(75) Inventor: Henry S. Eilts, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/114,597

(22) Filed: Apr. 25, 2005

(51) Int. Cl. H04M 1/00

(52) U.S. Cl. 455/556.1; 235/383

(57) ABSTRACT

According to one embodiment, a method includes determining an orientation of a portable communication device and controlling an aspect of the operation of the portable communication device based on the determined orientation.

### TECHNICAL FIELD OF THE INVENTION

This invention relates generally to mobile voice and data communication and more particularly to a method and system for controlling an aspect of the operation of a portable communication device based on a determined orientation, including position, of the device.

### BACKGROUND OF THE INVENTION

Wireless communications devices are becoming increasingly popular in today's society. Example wireless devices include wireless phones, often referred to as cellular phones, as well as wireless devices operable to communicate data. A personal digital assistant operable to send e-mails, such as the popular “Blackberry,” is an example of such a wireless communication device. Design challenges associated with such wireless devices include battery life, signal quality, and the design of user-friendly user interfaces.

As is commonly known, conventional operation of a phone involves placement of a portion of the phone near an ear of a user. Both mobile phones and other wireless devices conventionally utilize electronic displays, which can use relatively large amounts of power.

### SUMMARY OF THE INVENTION

According to one embodiment, a method includes determining an orientation of a portable communication device and controlling an aspect of the operation of the portable communication device based on the determined orientation.

Embodiments of the invention may provide numerous technical advantages. Some, none, or all of embodiments may benefit from the below-described advantages. According to one embodiment of the invention, a method and system are provided that utilize orientation information of a portable communication device received from sensors on or within the portable communication device. Appropriate selection of one of many possible antenna operations may be made based on the orientation information. This allows for better reception and transmission of voice or data than would otherwise be possible with a static antenna pattern. According to another embodiment of the invention, the orientation of a portable communication device with respect to a user's ear allows altering an associated antenna pattern to reduce antenna radiation directed in the direction of a user's ear, which some users may find desirable. According to another embodiment, power usage may be reduced by turning off or lowering power to certain aspects of the portable communication device, such as a display, based on its orientation. This allows for increased battery life. In another embodiment, a more user-friendly display may be provided that changes orientation based on the orientation of the portable communication device.

Other technical advantages will be readily apparent to one skilled in the art.

### BRIEF DESCRIPTION OF THE DRAWINGS

For a more complete understanding of the present invention and its advantages, references now made to the following description, taken in conjunction with the accompanying drawings, in which:

FIGS. 1A through 1D are a series of schematic illustrations showing various possible orientations of a portable communication device;

FIG. 2A is a block diagram of a portable communication device according to the teachings of the invention;

FIG. 2B is a block diagram of a portion of the portable communication device of FIG. 2A; and

FIG. 3 is a flowchart illustrating example steps associated with a method for controlling an aspect of the operation of a portable communication device based on an orientation of the portable communication device.

### DETAILED DESCRIPTION OF THE INVENTION

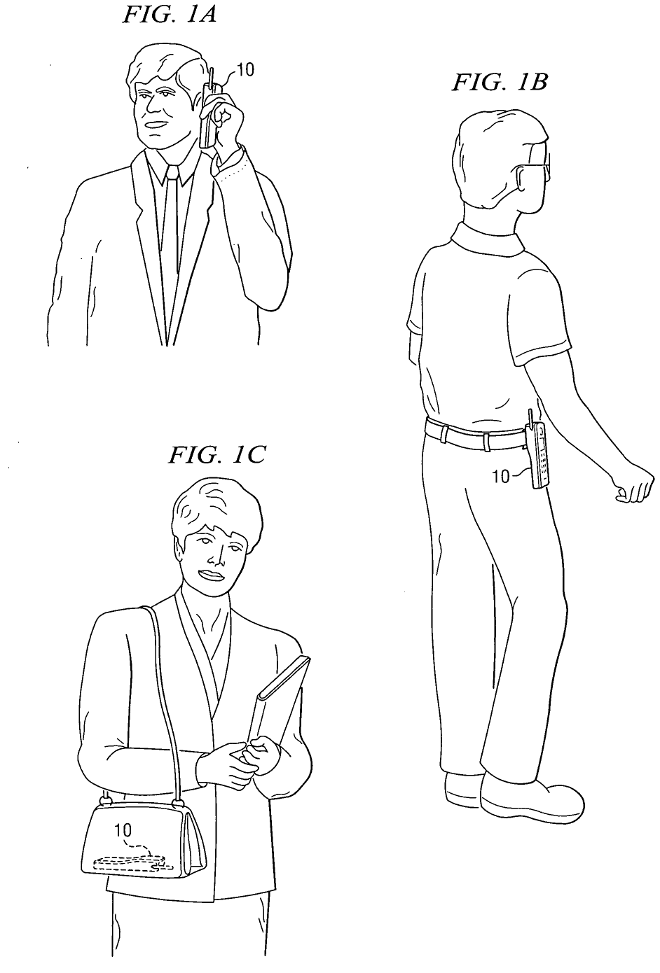

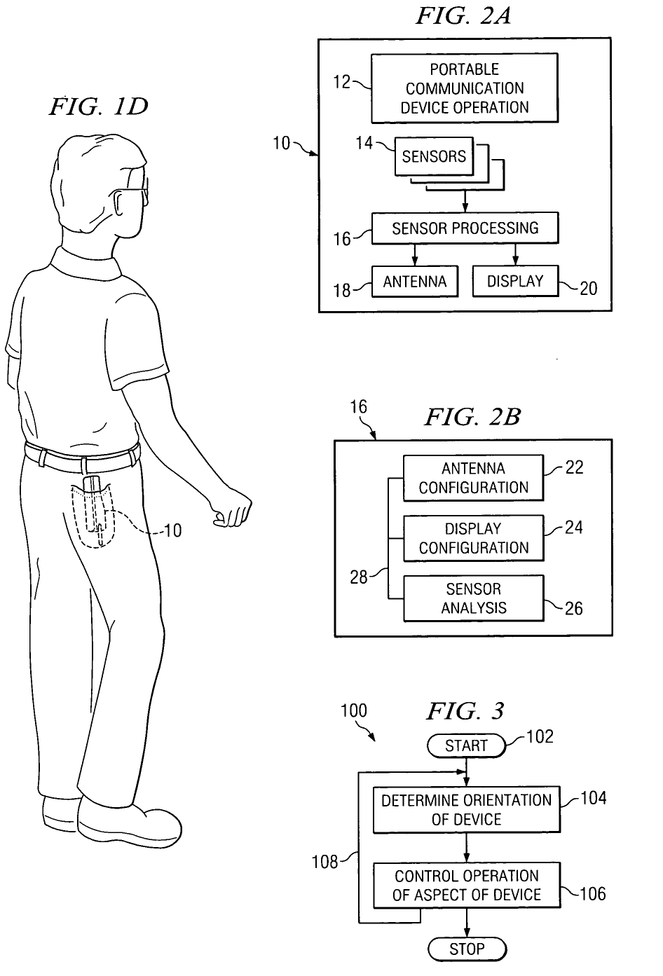

Embodiments of the present invention and its advantages are best understood by referring to FIGS. 1 through 3 of the drawings, like numerals being used for like and corresponding parts of the various drawings.

FIGS. 1A through 1D are schematic diagrams illustrating various possible orientations of a portable communication device 10. Examples of portable communication devices 10 include a wireless telephone, often referred to as a cellular telephone, as well as personal digital assistants operable to send data, such as e-mails. The below description uses a cell phone as an example; however, the teachings of the invention are also applicable to portable communication devices other than cell phones.

A typical cell phone is often carried in many various ways, as illustrated in FIGS. 1A through 1D. In one example, a user holds the cell phone to his ear when using the telephone, as illustrated in FIG. 1A. Alternatively, a user may carry the phone on his belt in a small carrier to hold the cell phone. In this example, the cell phone is usually positioned in an upright manner. FIG. 1C illustrates a cell phone positioned in a purse of a user. In this example, the orientation of the phone could take many forms depending upon contents of the purse and the shape of the phone. In another example illustrated in FIG. 1D, the user carries a cellular phone in a pocket. Again in this example the cellular phone may take various orientations. As used herein, orientation refers to either or both of the angular orientation of the cell phone with respect to some location, such as the earth's surface, and the position of the phone with respect to some other object, such as a user's ear.

Many cell phones are equipped with a monopole antenna for the cellular phone service. Monopole antennas often have a torroidal antenna pattern, which is donut shaped, with the best response being orthogonal to the axis of the monopole. If the phone is held horizontally (generally parallel to the earth's surface), a large part of the antenna's use pattern is directed into the ground or into the sky where it is wasted. Similarly, newer phones are equipped with global positioning system receivers and may have a microstrip patch for planar inverted F antennas. These antennas have roughly hemispherical patterns with a hemisphere oriented orthogonal to the surface of the antenna. Thus if these antennas are facing downward because of the carrying position of the cell phone, almost all the antenna pattern will be directed to the ground, preventing or degrading GPS reception. Further, when a cell phone is in use against a user's ear, such as illustrated in FIG. 1A, the cell phone receives little energy through the user's head, and receives most of the energy from directions not obstructed by the user.

The teachings of the invention recognize that cell phone performance could be improved if the cell phone were “smart” and knew its orientation. Thus, according to the teachings of the invention, a cell phone (or other portable communication device) is provided with one or more sensors on or within the phone that determine the phone orientation. Based upon the phone orientation, an antenna pattern selection algorithm may be executed that controls antenna selection among multiple antennas or, alternatively, controls the beam selection among beams of a multiple-beam array antenna. Further, the teachings of the invention recognize that knowing the orientation of the cellular telephone (or other portable communication device) may be used to control other aspects of operation of the cellular telephone. In one example, knowing that the cell phone is near the ear of user would allow the cell phone to automatically switch off the display, which could save power. In another example, the orientation of the display could be switched from horizontal to vertical (or other suitable orientation) if it is detected that the telephone is held in an orientation that would make a vertical display preferable. FIGS. 2A through 3 illustrate a system and method providing example details associated with controlling an aspect of a portable communication device based on a determined orientation of the portable communication device.

FIG. 2A is a block diagram of a portable communication device 10 according to the teachings of the invention. As described above, portable communication device 10 may be a cellular telephone, a wireless telephone other than a cellular telephone, or other portable communication device, such as wireless devices operable to transmit data, such as e-mails. One example of such a wireless e-mail device is commonly referred to as a “Blackberry.” FIG. 2A illustrates portable communication device 10 as having a plurality of functional components including a portable communication device operation system 12, a sensor system 14, a sensor processing system 16, an antenna system 18, and a display 20. Portable communication device operation system 12 refers to aspects of operation of the portable communication device 10 other than the other listed components, including receiving and transmitting voice or data and standard call processing functions.

Sensor system 14 includes one or more sensors operable to detect an orientation of portable communication device 10. Example sensors include a gravity sensor, a G-force sensor, and electronic gyroscopes. Electronic gyroscopes are often implemented as silicon devices that can provide orientation information. Other example sensors that may be used in sensor system 14 include accelerometers and inertial navigation units. In these examples, sensor system 14 may determine an angular orientation of portable communication device 10 with respect to some reference coordinate system. One possible coordinate system is the North-East-Down (x,y,z) earth based coordinate system at the device location.

Other example sensors include sensors that detect the orientation of portable communication device 10 with respect to a user's ear, such as a thermal sensor and a contact switch. The teachings of the invention recognize that a temperature sensor could be provided near the loudspeaker of the phone that would sense the user's skin temperature if the phone were held next to the skin. In one embodiment, this temperature sensor is incorporated with an ambient temperature sensor in the phone to determine the temperature of the surrounding air. Based upon a difference in the temperature, a determination could be made whether the portable communication device is against the ear of the user based upon the measured skin and ambient temperatures. In one example, this determination may be made by sensor processor 16, which is described in greater detail below, or by other suitable techniques or logic. In some instances, the ambient temperature and the skin temperature may be the same, making the “against the ear” decision difficult. However, these scenarios will likely be rare.

Alternatively, the “against the ear decision” may be made by a contact sensor that determines when the earpiece of the phone is physically touching a person. Examples of such as contact sensor are a pressure sensor and a capacitive sensor, such as for example, a sensor that changes capacitance when it is positioned against a person's skin. Because skin contact may be erratic while the phone is in use, an algorithm with some histeresis or filtering can be used. Such an algorithm may be included in sensor processing system 16, or on other locations of portable communication device 10.

“G”-force sensors that sense acceleration or gravity are commonly constructed on integrated circuits using MEMs technology. Thus, these sensors may be integrated on the integrated circuit that does the receiver/transmitter functions within portable communication operation system 12. In addition, magnetic sensors may also be used to sense the local direction of the earth's magnetic field. Since the magnetic field is approximately horizontal over most of the earth, the phone orientation can be inferred from the magnetic field direction.

FIG. 2B is a block diagram illustrating one example of sensor processing system 16. FIG. 2B illustrates an antenna configuration block 22, a display configuration block 24, and a sensor analysis system 26. Sensor processing system 16 includes logic encoded in software or firmware that receives an indication of the orientation of portable communication device 10 and performs necessary processing to determine appropriate action. For example, sensor analysis block 16 may determine the orientation of portable communication device 10 based upon sensor signals and provide the determined orientation over lines 28 to antenna configuration system 22. In response, antenna configuration system 22 may select from one of multiple antennas in antenna system 18 to use, or alternatively, control the beam selection among a plurality of possible beams of a multiple beam array antenna. As another example of the possible control of an aspect of the operation of portable communication device 10 based upon determined orientation of portable communication device 10 provided over lines 28, display configuration block 24 may control display 20 of portable communication device 10. For example, display 20 may be turned off if it is determined that portable communication device 10 is against the ear of a user. As another example, the orientation of the display may be rotated, such as from horizontal to vertical, to provide an orientation of the display to the user perceived to be useful to the user.

Referring back to FIG. 2A, antenna system 18 may include a plurality of alternative antennas or a multi-beam array antenna with a beam selectable by sensor processing 16. In the example of determining that the portable communication device 10 is placed against the ear of a user, sensor processing system 16, and in particular antenna configuration system 22, may cause antenna system 18 to produce a cardioid pattern with improved gain in the directions of interest and reduced gain in the direction of the head. This has the additional advantage of addressing any user's concerns over the radiation reduced by a cellular telephone that is directed toward the head of the user.

Display 20 may be a conventional display of a global communication device but, as described above, may be responsive to sensor processing system 16, and in particular display configuration system 24, to change its orientation or to turn off its power based upon the orientation of global communication device 10.

FIG. 3 is a flowchart illustrating a method 100 for controlling an aspect of the operation of a portable communication device based upon the orientation of the portable communication device. The method begins at step 102. At step 104 a determination of the orientation of a portable communication device is made. As described above, this determination may involve receiving an indication of the orientation of the portable communication device by one or more sensors placed on or within the portable communication device. Examples of such sensors include a gravity sensor, a G-force sensor, an electronic gyroscope, an accelerometer, an internal navigation unit, a thermal sensor, and a contact switch. This determined orientation may include either or both of an angular orientation of the portable communication device with respect to some reference, such as the earth, and an orientation with respect to a particular location, such as a user's ear.

Based on the determined orientation, an aspect of the operation of the portable communication device is controlled at step 106. One example of the control of an aspect of the operation of a portable communication device, in the case where the portable communication device is a wireless telephone, involves adjusting the antenna beam generated by the portable communication device such that it points generally away from a user's head. Another example involves selecting a desired effective antenna pattern by selecting from one of a plurality of antennas or by selecting a particular beam from a multi-beam array antenna to provide a desired antenna operation based on the orientation of the portable communication device. As another example, the operation of a display of a portable communication device may be controlled. Power may be terminated, or adjusted, to the display based upon this determination. For example, if it is determined that the portable communication device is on the ear of a user, the display may be turned off. In another example, the orientation of a display may be changed from, for example, horizontal to vertical if it is detected that such an orientation would be appropriate based on the orientation of portable communication device 10. Numerous other aspects of the operation of portable communication device 10 may be utilized based upon the determined orientation of the portable communication device. This method may continue continuously as indicated at step 108, or conclude at step 110.

Although the present invention has been described with several embodiments, a myriad of changes, variations, alterations, transformations, and modifications may be suggested to one skilled in the art, and it is intended that the present invention encompass such changes, variations, alterations, transformation, and modifications as they fall within the scope of the appended claims.

What is claimed is:

1. A method comprising:
determining an orientation of a portable communication device; and
controlling an aspect of the operation of the portable communication device based on the determined orientation of the portable communication device.

2. The method of claim 1, wherein controlling an aspect of the operation of the portable communication device comprises configuring an antenna pattern of the portable communication device based on the determined orientation of the portable communication device.

3. The method of claim 1, wherein controlling an aspect of the operation of the portable communication device comprises configuring an antenna pattern of the portable communication device based on the determined orientation of the portable communication device to be generally away from an ear of a user of the portable communication device.

4. The method of claim 1, wherein controlling an aspect of the operation of the portable communication device comprises configuring an antenna pattern of the portable communication device based on the determined orientation of the portable communication device to be generally upward with respect to the earth.

5. The method of claim 1, wherein determining an orientation of the portable communication device comprises determining an orientation of the portable communication device using a sensor selected from the group consisting of a gravity sensor, a G-force sensor, an electronic gyroscope, an accelerometer, an internal navigation unit, a thermal sensor, and a control switch.

6. The method of claim 1, wherein determining an orientation of the portable communication device comprises determining an orientation of the portable communication device with respect to an ear of the user of the portable communication device.

7. The method of claim 1, wherein the portable communication device is selected from the group consisting of a wireless telephone and a device operable to transmit data wirelessly.

8. The method of claim 7, wherein the data comprises an e-mail.

9. The method of claim 6, wherein determining an orientation of the portable communication device comprises determining an orientation of the portable communication device with respect to an ear of a user of the portable communication device by a temperature sensor.

10. The method of claim 6, wherein determining an orientation of the portable communication device comprises determining an orientation of the portable communication device with respect to an ear of a user of the portable communication device using a contact sensor.

11. The method of claim 1, wherein controlling an aspect of the operation of the portable communication device comprises configuring an orientation of a display of the portable communication device based on the determined orientation.

12. The method of claim 1, wherein controlling an aspect of the operation of the portable communication device comprises controlling power to a display of the portable communication device.

13. A method comprising:
determining, using at least one sensor associated with a wireless telephone, the orientation of the wireless telephone with respect to the earth; and
controlling an antenna pattern of the wireless telephone based on the determined orientation.

14. The method of claim 13, wherein determining, using at least one sensor, comprises determining the orientation of the phone with respect to the earth using a sensor selected from the group consisting of a gravity sensor, a G-force sensor, an electronic gyroscope, an accelerometer, and an inertial navigation unit.

15. The method of claim 13, wherein the at least one sensor is one of on the wireless telephone and within the wireless telephone.

16. A system comprising:
a portable communication device comprising:
at least one sensor operable to sense an indication of the orientation of the portable communication device; and
logic operable to:
determine an orientation of the portable communication device in response to the sensed indication; and
control an aspect of operation of the portable communication device based on the determined orientation of the portable communication device.

17. The system of claim 16, wherein the portable communication device is selected from the group consisting of a wireless telephone and a device operable to transmit data wirelessly.

18. The system of claim 16, wherein the at least one sensor is selected from the group consisting of gravity sensor, a G-force sensor, an electronic gyroscope, an accelerometer, an inertial navigation unit, a thermal sensor, and a contact switch.

19. The system of claim 16, wherein the logic is further operable to control an antenna pattern of the portable communication device.

20. The system of claim 16, wherein the logic is further operable to control a display of the portable communication device.
